(19) United States
(12) Patent Application Publication
(10) Pub. No.: US 2026/0267541 A1
(43) Pub. Date: Sep. 10, 2026

(54) RECORDING MEDIUM, SYSTEM STARTING METHOD, AND INFORMATION PROCESSING DEVICE

(71) Applicant: Fujitsu Limited, Kawasaki-shi (JP)

(72) Inventor: Yukinobu NONOMURA, Kawasaki (JP)

(73) Assignee: Fujitsu Limited, Kawasaki-shi (JP)

(21) Appl. No.: 19/460,899

(22) Filed: Jan. 27, 2026

(30) Foreign Application Priority Data
Mar. 4, 2025 (JP) 2025-033870

(51) Int. Cl. G06F 3/06

(52) U.S. Cl. CPC G06F 3/0629; G06F 3/0604; G06F 3/0673

(57) ABSTRACT

A computer-readable recording medium stores a program causing a computer to execute: reading memory configuration information from a nonvolatile memory, when a system including a main memory, an expansion memory, and the nonvolatile memory is started, the memory configuration information representing a configuration of the expansion memory at a last startup of the system; establishing in the main memory, based on the memory configuration information, an area for storing access attribute management information for an area usable by an OS; recognizing the configuration in response to detection of the expansion memory during startup of the system; determining whether the configuration has changed based on comparison of the configuration represented by the memory configuration information and the recognized configuration; writing updated memory configuration information and restarting the system, the updated memory configuration information representing the recognized configuration and written to the nonvolatile memory when the configuration has changed; and starting the OS when the configuration has not changed.

### CROSS REFERENCE TO RELATED APPLICATIONS

This application is based upon and claims the benefit of priority of the prior Japanese Patent Application No. 2025-033870, filed on Mar. 4, 2025, the entire contents of which are incorporated herein by reference.

### FIELD

The embodiments discussed herein are related to a recording medium, a system startup method, and an information processing device.

### BACKGROUND

Conventionally, there is a system in which a large capacity memory such as a Dual Inline Memory Module (DIMM) or a Compute Express Link (CXL) memory may be implemented. In the physical address space of the system, an access attribute of a memory area that may be used by an operating system (OS) is managed using, for example, information called an attribute management table. The attribute management table is generated when the system is started and stored in a main memory such as a DIMM.

As a related art, for example, there is a memory system that includes a controller that manages a first area used as a main memory by a host and a second area in which valid data is stored in a memory space provided to the host to which an area of a nonvolatile memory is mapped. For example, refer to Japanese Laid-Open Patent Publication No. 2023-007761.

### SUMMARY

According to an aspect of an embodiment, a computer-readable recording medium stores therein a program for causing a computer to execute a process, the process including: reading memory configuration information from a nonvolatile memory, when a system including a main memory, an expansion memory, and the nonvolatile memory is started, the memory configuration information representing a configuration of the expansion memory recognized at a last startup of the system; establishing in the main memory and based on the read memory configuration information, an area for storing attribute management information for managing an access attribute of an area usable by an OS in an entire physical address space of the system; recognizing the configuration of the expansion memory in response to detection of the expansion memory during startup of the system; determining whether the configuration of the expansion memory has changed based on a result of comparison of the configuration of the expansion memory represented by the memory configuration information and the recognized configuration of the expansion memory; writing updated memory configuration information and restarting the system, the updated memory configuration information representing the recognized configuration of the expansion memory and being written to the nonvolatile memory when the configuration of the expansion memory has changed; and starting the OS when the configuration of the extension memory has not changed.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is an explanatory diagram depicting an example of a system startup method according to an embodiment.

FIG. 2 is a block diagram depicting an example of a hardware configuration of an information processing device 100.

FIG. 3 is a block diagram depicting an example of a functional configuration of the information processing device 100.

FIG. 4 is a flowchart depicting an example of a procedure of a system startup process of the information processing device 100.

FIG. 5 is an explanatory diagram depicting a comparative example of an OS-usable area.

FIG. 6 is an explanatory diagram depicting a configuration example of firmware.

FIG. 7 is an explanatory diagram depicting an example of a format of a DIMM configuration determination result.

FIG. 8 is an explanatory diagram depicting a format example of CXL memory configuration information.

FIG. 9 is a sequence diagram depicting a procedure of the system startup process of the information processing device 100 according to the embodiment.

FIG. 10 is a sequence diagram depicting a procedure of the system startup process of the information processing device 100 according to the embodiment.

FIG. 11 is a sequence diagram depicting a procedure of the system startup process of the information processing device 100 according to the embodiment.

FIG. 12 is an explanatory diagram depicting an example of an area under management.

### DESCRIPTION OF EMBODIMENTS

First, problems associated with the conventional technique are discussed. In the related art, there is a problem in that the size of an area established for storing information for managing access attributes (for example, an attribute management table) increases and a memory area usable by the OS may decrease.

Embodiments of a computer-readable recording medium, a system startup method, and an information processing device according to the present disclosure will be explained below in detail with reference to the accompanying drawings.

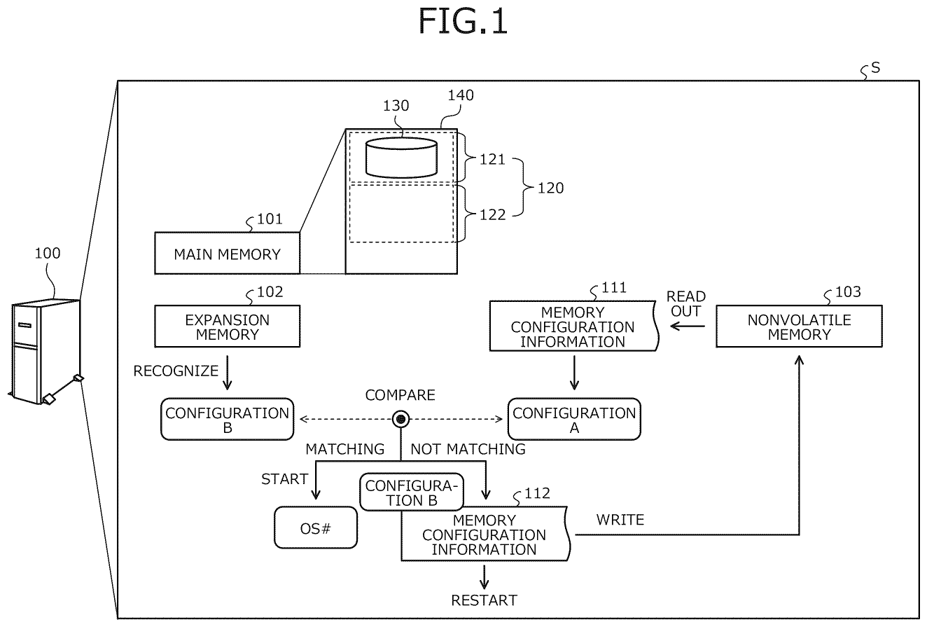

FIG. 1 is an explanatory diagram depicting an example of a system startup method according to an embodiment. In FIG. 1, an information processing device 100 is a computer on which a system S operates. The information processing device 100 is, for example, a server. The information processing device 100 may be a personal computer (PC).

The system S is a computer system on which a large-capacity memory may be implemented. The system S is applied to, for example, a server system that performs AI training or inference, a server system that provides software as a service (SaaS), a high-performance computer (HPC), or the like.

The system S includes a main memory 101, an expansion memory 102, and a nonvolatile memory 103. The main memory 101 is, for example, a DIMM. The expansion memory 102 is a configurable memory device. The expansion memory 102 is, for example, a peripheral component interconnect-express (PCIe) device. The PCIe device is a PCIe-coupled device and is, for example, a CXL memory. The nonvolatile memory 103 is, for example, a flash ROM.

Access attributes of the memory area usable by an OS# in the physical address space of the system S is managed using attribute management information 130. The OS# is software that manages the entire system S. The attribute management information 130 is information for managing the access attributes of areas under management. An area under management indicates a target area for which access attributes are dynamically managed in the entire physical address space of the system S. The area under management corresponds to a memory area usable by the OS#.

The attribute management information 130 is used, for example, to manage an access attribute such as secure/non-secure for each page size, and dynamically set or manage the access attribute in units of page size during the operation of the system S. The attribute management information 130 is generated when the system S is started and stored to the main memory 101. The attribute management information 130 is, for example, information in a table format (attribute management table).

In a conventional method, an area under management is not an area that is actually mounted in the system and is memory-mapped, but an area having a maximum configuration that may be logically taken in the system. In the conventional method, an area for storing an attribute management table (for example, corresponding to the attribute management information 130) is statically established in advance in the DIMM area. The area usable by the OS is an area obtained by subtracting the area for storing the attribute management table (attribute management table area) from the actually mounted memory capacity.

However, in the conventional method, in a system having a large memory area in terms of specifications, there is a problem in that the capacity of the attribute management table area that is statically established increases and the memory area that may be used by the OS decreases. For example, when a memory having a minimum configuration in the system is mounted, the attribute management table area occupies a considerable portion of the memory area actually mounted and the area usable by the OS is reduced.

Here, instead of statically securing the capacity of the maximum logical configuration, it is conceivable to dynamically recognize the actually mounted capacity and establish the minimum necessary attribute management table area. However, in the case of a PCIe device such as a CXL memory, the CXL memory is recognized by firmware such as UEFI after the generation timing of the attribute management table at the time of system startup. UEFI is an abbreviation for unified extensible firmware interface.

In this case, when the attribute management table is generated, since the total capacity actually mounted in the CXL memory as the area under management is unknown, the minimum size of the attribute management table area necessary in the system cannot be specified. Therefore, in the conventional method, it is not possible to dynamically recognize the actually mounted capacity and establish the attribute management table area.

Therefore, in the present embodiment, a system startup method will be described in which an area for storing the attribute management information 130 is established according to the configuration of the expansion memory 102 actually mounted on the system S to increase the memory area usable by the OS#. Here, an example of a process of the information processing device 100 will be described.

(1) The information processing device 100 reads memory configuration information 111 from the nonvolatile memory 103 when the system S is started. Here, the memory configuration information 111 represents the configuration (“configuration A” in FIG. 1) of the expansion memory 102 recognized at the previous startup of the system S. The memory configuration information 111 is, for example, information stored in the nonvolatile memory 103 at the time of the previous startup of the system S.

(2) Based on the read memory configuration information 111, the information processing device 100 establishes, in the main memory 101, an area (attribute management information area 121) for storing attribute management information 130 for managing an access attribute of an area usable by OS# in the entire physical address space of the system S.

Specifically, for example, the information processing device 100 identifies the total capacity of the expansion memory 102 from the configuration (“configuration A” in FIG. 1) of the expansion memory 102 indicated by the memory configuration information 111. Next, the information processing device 100 calculates the size of the attribute management information area 121 based on the total capacity of the main memory 101 and the identified total capacity of the expansion memory 102.

The total capacity of the main memory 101 may be set in advance. The information processing device 100 may recognize the configuration of the main memory 101 when the system S is started and specify the total capacity of the main memory 101 from the recognized configuration of the main memory 101. Unlike the expansion memory 102, the configuration of the main memory 101 may be recognized before the generation timing of the attribute management information 130.

Then, the information processing device 100 establishes the attribute management information area 121 of the calculated size in the main memory 101. The attribute management information 130 is generated in an attribute management information area 121 established in the main memory 101. An area (OS usable area 122) usable by the OS# in the main memory 101 is an area obtained by excluding the attribute management information area 121 from the mounted portion 120 (actually mounted memory capacity) in the main memory area map 140. The capacity of the mounted portion 120 corresponds to, for example, the total capacity of the main memory 101. The main memory area map 140 indicates a maximum area (an area having a maximum logical configuration) of the main memory 101.

(3) The information processing device 100 recognizes the configuration (“configuration B” in FIG. 1) of the extension memory 102 in response to detection of the extension memory 102 during startup of the system S. The configuration of the expansion memory 102 is recognized by firmware such as UEFI after the generation timing of the attribute management information 130.

(4) The information processing device 100 determines whether the configuration of the expansion memory 102 has been changed, based on a result of comparison between the configuration (“configuration A” in FIG. 1) of the expansion memory 102 indicated by the read memory configuration information 111 and the recognized configuration (“configuration B” in FIG. 1) of the expansion memory 102. For example, when the expansion memory 102 is added or removed while the system S is stopped (before startup), it is determined that the configuration of the expansion memory 102 has changed.

(5) When the configuration of the expansion memory 102 has changed, the information processing device 100 writes memory configuration information 112 indicating the recognized configuration (“configuration B” in FIG. 1) of the expansion memory 102 into the nonvolatile memory 103 and restarts the system S. When the configuration of the expansion memory 102 has not changed, the information processing device 100 starts the OS#.

As described above, according to the information processing device 100, the size of the attribute management information area 121 in the main memory 101 may be reduced as compared with a case where an area corresponding to the capacity of the maximum logical configuration is statically established for the expansion memory 102. Thus, the information processing device 100 may optimize the attribute management information area 121 and increase the memory area (OS usable area 122) usable by the OS#.

In the example depicted in FIG. 1, it is possible to increase the OS usable area 122 by suppressing the size of the attribute management information area 121 in the mounted portion 120 (the memory capacity actually mounted) of the main memory 101.

Next, an example of a hardware configuration of the information processing device 100 will be described. In the following description, a case where the main memory 101 of the system S is “DIMM”, the expansion memory 102 is “CXL memory”, and the nonvolatile memory 103 is a “flash ROM 202” will be described as an example.

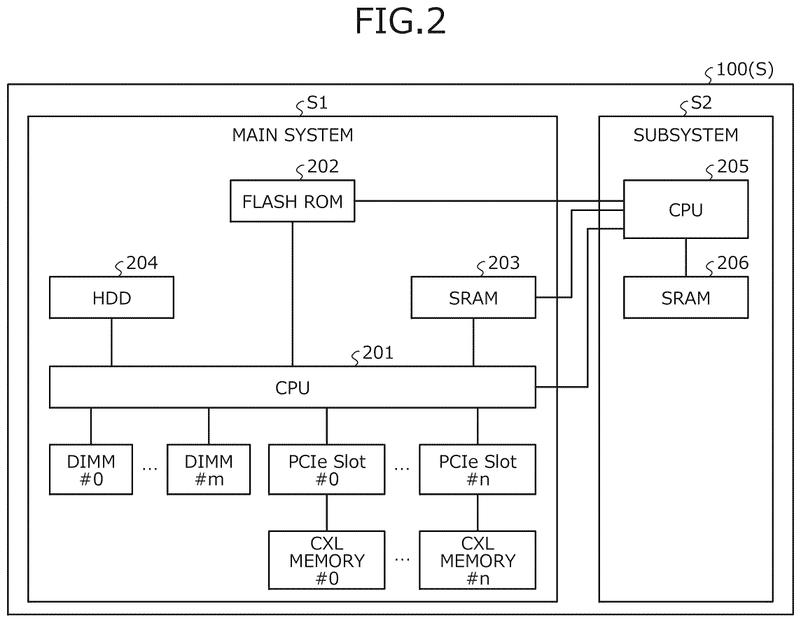

FIG. 2 is a block diagram depicting an example of a hardware configuration of the information processing device 100. As depicted in FIG. 2, in the information processing device 100, the system S includes a main system S1 and a subsystem S2. The main system S1 includes a central processing unit (CPU) 201, a flash read-only memory (ROM) 202, a static random access memory (SRAM) 203, a hard disk drive (HDD) 204, DIMMs #0 to #m (m is a natural number), and CXL memories #0 to #n (n is a natural number). The components are coupled by a bus.

The CPU 201 controls the entire main system S1. The CPU 201 may include multiple cores. The flash ROM 202 stores programs and data. A program stored in the flash ROM 202 is, for example, loaded onto the CPU 201 to cause the CPU 201 to execute an encoded process. The nonvolatile memory 103 depicted in FIG. 1 corresponds to, for example, the flash ROM 202.

The SRAM 203, the DIMMs #0 to #m, and the CXL memories #0 to #n are used as work areas of the CPU 201. The DIMMs #0 to #m and the CXL memories #0 to #n are configurable memories. The CXL memories #0 to #n are coupled to the CPU 201 via PCIe slots #0 to #n, respectively. The main memory 101 depicted in FIG. 1 corresponds to, for example, the DIMMs #0 to #m. The expansion memory 102 depicted in FIG. 1 corresponds to, for example, the CXL memories #0 to #n.

The HDD 204 is an auxiliary storage device and controls the reading and writing of data with respect to a disk, under the control of the CPU 201. The main system S1 may include, for example, a solid-state drive (SSD) instead of the HDD 204.

The subsystem S2 includes a CPU 205 and an SRAM 206. The components are coupled by a bus. The CPU 205 controls the entire subsystem S2. The CPU 205 operates independently of the CPU 201 of the main system S1. The CPU 205 has an interface for accessing the flash ROM 202, the SRAM 203, and the CPU 201 of the main system S1 in order to exchange information with the main system S1. The SRAM 206 is used as a work area of the CPU 205.

Note that the information processing device 100 may include, for example, a graphics processing unit (GPU), a communication interface (I/F), a portable recording medium I/F, a portable recording medium, an input device, a display, and the like in addition to the above-described components.

Next, an example of a functional configuration of the information processing device 100 will be described.

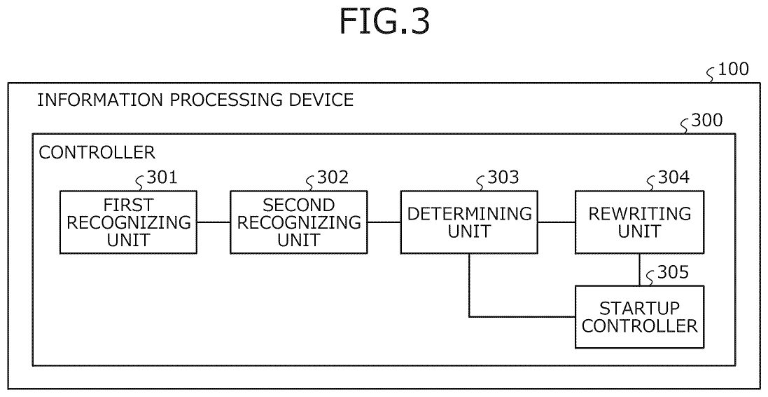

FIG. 3 is a block diagram depicting an example of a functional configuration of the information processing device 100. In FIG. 3, the information processing device 100 includes a first recognizing unit 301, a second recognizing unit 302, a determining unit 303, a rewriting unit 304, and a startup controller 305. The first recognizing unit 301 to the startup controller 305 are functions serving as a controller 300. Specifically, for example, the functions are realized by causing the CPU 201 to execute a program stored in a storage device such as the flash ROM 202 or the HDD 204 of the main system S1 depicted in FIG. 2. Processing results of the functional units are stored to a storage device such as the flash ROM 202, the SRAM 203, the HDD 204, or the DIMMs #0 to #m.

The first recognizing unit 301 recognizes the configuration of the DIMMs #0 to #m (corresponding to the main memory 101 depicted in FIG. 1) when the system S is started. Here, recognizing the configuration of the DIMMs #0 to #m may be, for example, recognizing the DIMMs actually mounted in the system S. Recognizing the configuration of the DIMMs #0 to #m may be recognizing a DIMM that is actually mounted in the system S and is not disabled due to a failure or the like.

For example, when the system S is started, the subsystem S2 (see FIG. 2) first recognizes the configurations of the DIMMs #0 to #m and writes configuration information (DIMM configuration determination result) representing the recognized configurations of the DIMMs #0 to #m to the SRAM 203. In this case, for example, the first recognizing unit 301 recognizes the configurations of the DIMMs #0 to #m with reference to the DIMM configuration determination result written in the SRAM 203.

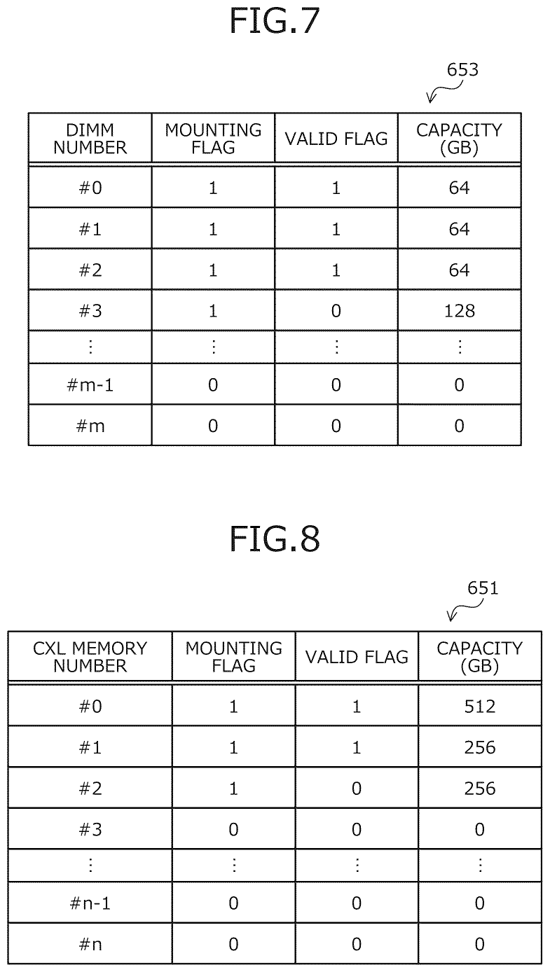

A specific example of the DIMM configuration determination result will be described later with reference to FIG. 7.

The first recognizing unit 301 reads the CXL memory configuration information from the flash ROM 202 (corresponding to the nonvolatile memory 103 depicted in FIG. 1) when the system S is started. Here, the CXL memory configuration information represents the configuration of the CXL memories #0 to #n (corresponding to the extension memory 102 depicted in FIG. 1) recognized at the previous startup of the system S. Then, the first recognizing unit 301 recognizes the configuration of the CXL memories #0 to #n recognized at the previous startup of the system S based on the read CXL memory configuration information.

A specific example of the CXL memory configuration information will be described later with reference to FIG. 8.

The first recognizing unit 301 establishes an attribute management table area for storing the attribute management table in the DIMMs #0 to #m. Here, the attribute management table is an example of attribute management information for managing access attributes for a memory area (area under management) usable by the OS#. Attribute management tables includes, for example, an attribute management table #1 and an attribute management table #2.

The attribute management table #1 is information for controlling the access attributes of an area under management by hardware. The attribute management table #2 is information for controlling the access attributes of an area under management by software. An area under management is a memory area for which access attributes are managed in the entire physical address space of the system S.

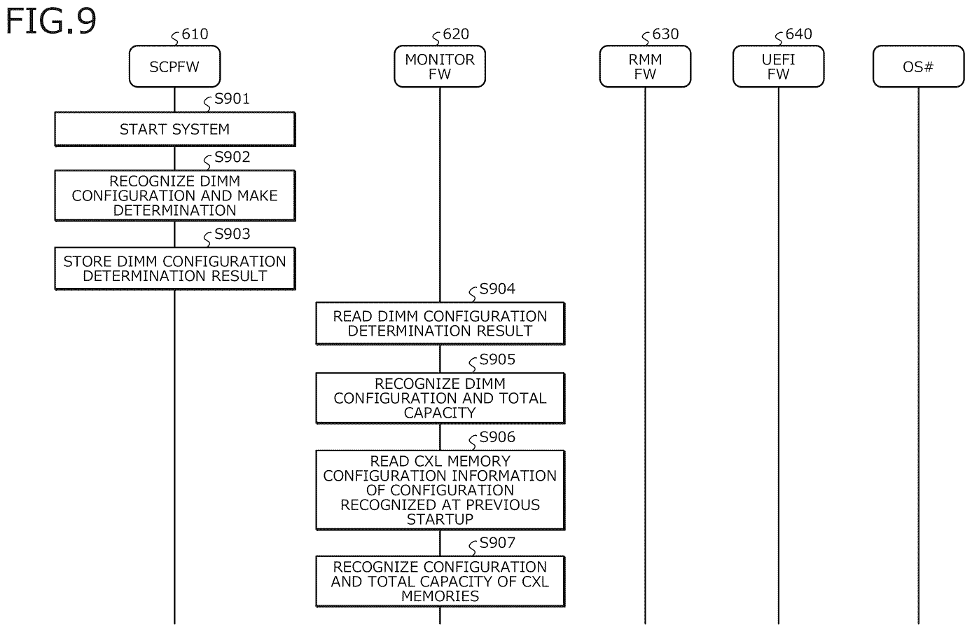

A specific example of an area under management will be described later with reference to FIG. 9.

Specifically, for example, the first recognizing unit 301 identifies the total capacity of the DIMMs #0 to #m from the recognized configurations of the DIMMs #0 to #m. In addition, the first recognizing unit 301 identifies the total capacity of the CXL memories #0 to #n from the recognized configurations of the CXL memories #0 to #n (the configurations recognized at the time of the previous startup of the system S). Next, the first recognizing unit 301 calculates the total capacity of the total capacity of the identified DIMMs #0 to #m and the total capacity of the identified CXL memories #0 to #n.

Then, the first recognizing unit 301 recognizes an area in which the calculated total capacity is memory-mapped as an area under management. Next, the first recognizing unit 301 calculates the sizes (capacities) of the attribute management tables #1 and #2 for managing the access attributes of the recognized area under management. Then, the first recognizing unit 301 establishes an attribute management table area corresponding to the calculated size in the DIMMs #0 to #m.

The attribute management tables #1 and #2 are generated in attribute management table areas established in the DIMMs #0 to #m. Specifically, for example, the first recognizing unit 301 generates the attribute management table #1 in the established attribute management table area. Further, the first recognizing unit 301 generates the attribute management table #2 in the established attribute management table area.

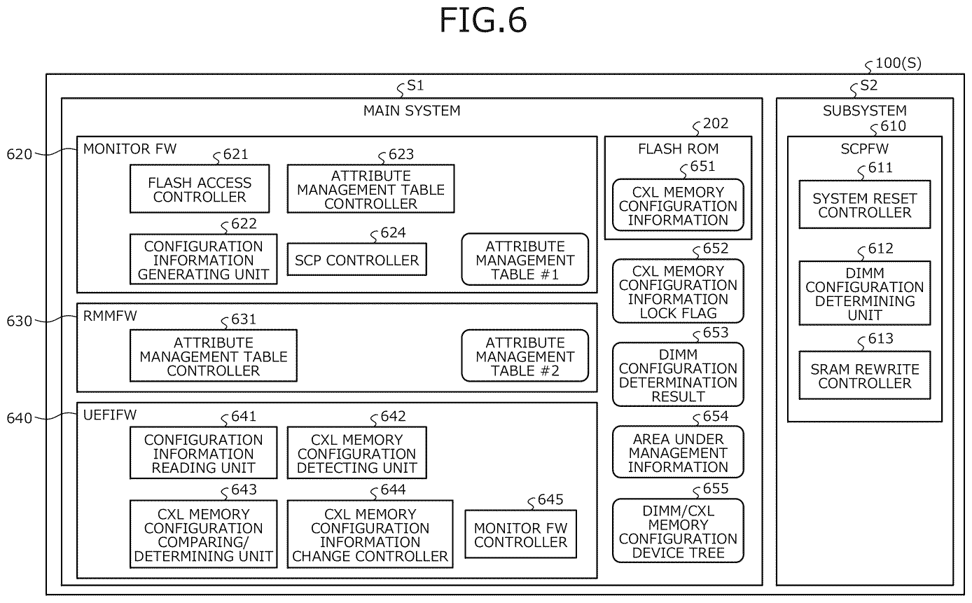

The second recognizing unit 302 recognizes the configuration of the CXL memories #0 to #n in response to detection of the CXL memories #0 to #n during startup of the system S. The CXL memories #0 to #n may be detected after initialization of the PCIe, for example, by a UEFIFW 640 depicted in FIG. 6 to be described later. Initialization necessary for starting the OS# such as initialization of the PCIe is performed after the generation timing of the attribute management tables #1 and #2.

The determining unit 303 compares the configuration of the CXL memories #0 to #n recognized by the first recognizing unit 301 (the configuration recognized at the previous startup of the system S) with the configuration of the CXL memories #0 to #n recognized by the second recognizing unit 302 (the configuration recognized at the current startup of the system S). Then, the determining unit 303 determines whether the configurations of the CXL memories #0 to #n have been changed, based on the comparison result.

When the configurations of the CXL memories #0 to #n have changed, the rewriting unit 304 writes into the flash ROM 202, CXL memory configuration information representing the configurations of the CXL memories #0 to #n recognized by the second recognizing unit 302 (the configurations recognized at the time of the current startup of the system S). When the configuration of the CXL memories #0 to #n has changed, the attribute management tables #1 and #2 are reconstructed and thus, the rewriting unit 304 rewrites the CXL memory configuration information to the flash ROM 202.

When the configuration of the CXL memories #0 to #n has changed, the startup controller 305 restarts the system S. Specifically, for example, after the rewriting unit 304 writes the CXL memory configuration information, the startup controller 305 restarts the system S by issuing a reboot instruction to the subsystem S2. The subsystem S2 reboots the system S in response to the reboot instruction.

When the configurations of the CXL memories #0 to #n have not changed, the startup controller 305 starts the OS#. When the OS# starts, the startup of the system S is completed.

Among the functional units of the information processing device 100, the first recognizing unit 301 is implemented using, for example, an attribute management table controller 623 of a monitor FW 620 and an attribute management table controller 631 of a RMMFW 630 depicted in FIG. 6 to be described later. The second recognizing unit 302 is implemented by using, for example, a CXL memory configuration detecting unit 642 of the UEFIFW 640 depicted in FIG. 6 to be described later. The determining unit 303 is implemented by using, for example, a configuration information reading unit 641 and a CXL memory configuration comparing/determining unit 643 of the UEFIFW 640 depicted in FIG. 6 described later. The rewriting unit 304 is implemented by using a CXL memory configuration information change controller 644 of the UEFIFW 640 depicted in FIG. 6 described later. The startup controller 305 is implemented by using, for example, a monitor FW controller 645 of the UEFIFW 640 and an SCP controller 624 of the monitor FW 620 depicted in FIG. 6 described later.

Next, a procedure of a system startup process of the information processing device 100 will be described.

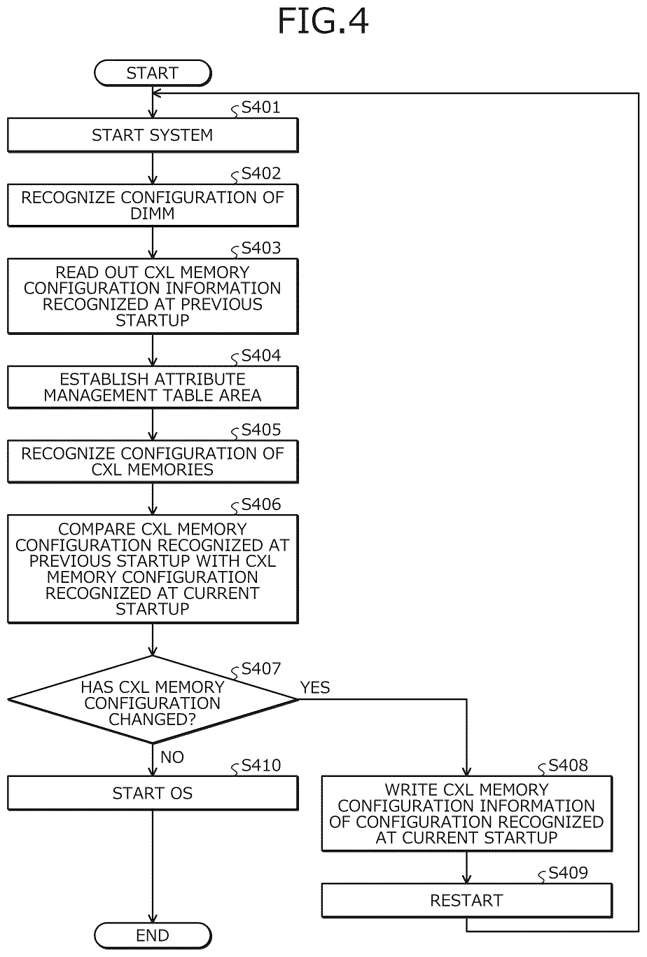

FIG. 4 is a flowchart depicting an example of the procedure of the system startup process of the information processing device 100. In the flowchart depicted in FIG. 4, first, the information processing device 100 starts the system S (step S401). Then, the information processing device 100 recognizes the configuration of the DIMMs #0 to #m (step S402).

Next, the information processing device 100 reads out from the flash ROM 202, the CXL memory configuration information representing the configuration of the CXL memories #0 to #n recognized at the previous startup of the system S (step S403).

Then, the information processing device 100 establishes an attribute management table area in the DIMMs #0 to #m based on the recognized configurations of the DIMMs #0 to #m and the configurations of the CXL memories #0 to #n indicated by the read CXL memory configuration information (step S404). Attribute management tables #1 and #2 are generated in the established attribute management table area.

Next, the information processing device 100 recognizes the configuration of the CXL memories #0 to #n in response to detection of the CXL memories #0 to #n during startup of the system S (step S405). Then, the information processing device 100 compares the configuration of the CXL memories #0 to #n recognized at the time of the previous startup with the configuration of the CXL memories #0 to #n recognized at the time of the current startup (step S406).

Next, the information processing device 100 determines whether the configurations of the CXL memories #0 to #n have been changed, on based on the comparison result (step S407). Here, when the configurations of the CXL memories #0 to #n have changed (step S407: YES), the information processing device 100 writes in the flash ROM 202, the memory configuration information indicating the configurations of the CXL memories #0 to #n recognized at the time of the current startup (step S408). Then, the information processing device 100 restarts the system S (step S409) and returns to step S401.

When the configuration of the CXL memories #0 to #n has not changed at step S407 (step S407: NO), the information processing device 100 starts the OS# (step S410) and ends the series of processes according to the flowchart.

Accordingly, the information processing device 100 establishes the attribute management table area according to the memory area mounted in the system S, thereby suppressing the size of the attribute management table area in the DIMMs #0 to #m and increasing the memory area usable by the OS#.

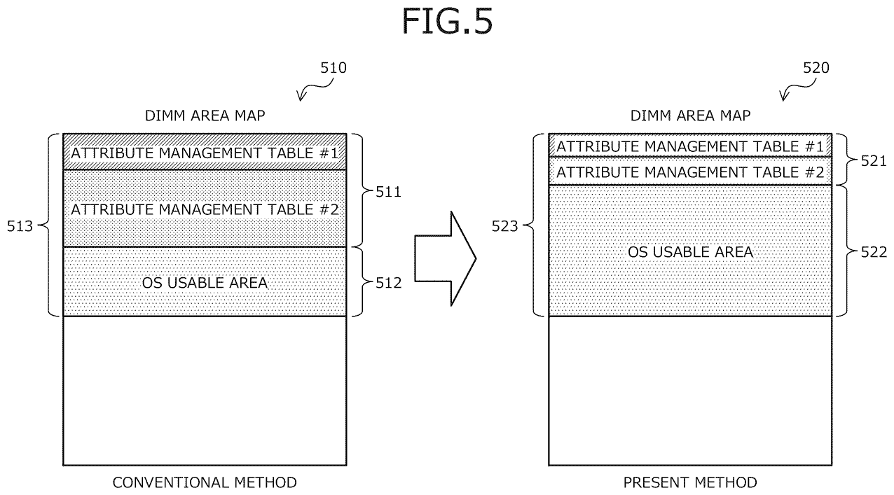

Here, a comparative example of the memory area usable by the OS# will be described with reference to FIG. 5.

FIG. 5 is an explanatory diagram depicting a comparative example of the OS-usable area. In FIG. 5, a DIMM area map 510 indicates a memory map in the DIMMs #0 to #m in a case where the attribute management table area 511 is statically established according to the capacity of the maximum logical configuration as in the conventional method (described as “conventional method” in FIG. 5). In the DIMM area map 510, the OS usable area 512 is an area obtained by subtracting the attribute management table area 511 from the mounted area 513 (mounted memory capacity).

The DIMM area map 520 indicates a memory map in the DIMMs #0 to #m in a case where an attribute management table area 521 is established according to the area implemented in the system S by the present system startup method (described as “present method” in FIG. 5). In the DIMM area map 520, an OS usable area 522 is an area obtained by subtracting the attribute management table area 521 from the mounted area 523 (mounted memory capacity).

According to the present system startup method, by suppressing the size of the attribute management table area 521 in the DIMM area map 520, it is found that the memory area usable by the OS# is increased as compared with the conventional method (OS usable area 512→OS usable area 522).

Next, an embodiment of the information processing device 100 will be described. First, a configuration example of firmware in the system S will be described with reference to FIG. 6.

FIG. 6 is an explanatory diagram depicting a configuration example of firmware. In FIG. 6, the subsystem S2 includes a system control processor firmware (SCPFW) 610. The SCPFW 610 includes a system reset controller 611, a DIMM configuration determining unit 612, and an SRAM rewrite controller 613.

The system reset controller 611 controls resetting of the main system S1. The DIMM configuration determining unit 612 recognizes and determines the configuration of the DIMMs #0 to #m of the main system S1. The SRAM rewrite controller 613 notifies the firmware of the main system S1 of the DIMM configuration determination result 653 (for example, refer to FIG. 7).

Here, the DIMM configuration determination result 653 will be described with reference to FIG. 7.

FIG. 7 is an explanatory diagram depicting an example of a format of a DIMM configuration determination result. In FIG. 7, the DIMM configuration determination result 653 indicates a DIMM number, a mounting flag, a valid flag, and a capacity (GB) for each DIMM. The DIMM number is an identifier for uniquely identifying the DIMM. The mounting flag indicates whether a DIMM is mounted in the DIMM slot. Here, the mounting flag “1” indicates that a DIMM is mounted. The mounting flag “0” indicates that a DIMM is not mounted.

The valid flag indicates whether the mounted DIMM is usable. Even when a DIMM is mounted, the DIMM may become unusable due to a failure or a configuration determination result of the system S. Here, the valid flag “1” indicates that the DIMM may be used. The valid flag “0” indicates that the DIMM cannot be used. The capacity (GB) indicates the capacity of the DIMM.

As depicted in FIG. 6, the main system S1 includes the monitor FW (boot loader firmware) 620, an RMMFW (attribute management firmware) 630, and the UEFIFW (UEFI firmware) 640. The monitor FW 620 operates first when the main system S1 is started and performs basic initialization. The RMMFW 630 manages an area under management (an area whose access attribute is to be managed) after the OS# is started. The UEFIFW 640 performs initialization necessary for booting the OS#, such as initialization of the PCIe not initialized by the monitor FW 620.

The monitor FW 620 operates in the SRAM 203 of the main system S1. The monitor FW 620 includes a flash access controller 621, a configuration information generating unit 622, an attribute management table controller 623, and an SCP controller 624. The monitor FW 620 includes an attribute management table #1 and a CXL memory configuration information lock flag 652. The attribute management table #1 is attribute management information (for hardware control) for controlling an access attribute of an area under management by hardware (for example, the CPU 201). The CXL memory configuration information lock flag 652 is flag information for locking rewriting of the CXL memory configuration information 651.

The flash access controller 621 accesses CXL memory configuration information 651 (for example, see FIG. 8) in the flash ROM 202. The configuration information generating unit 622 passes a DIMM/CXL memory configuration device tree 655 to the UEFIFW 640. The DIMM/CXL memory configuration device tree 655 includes a DIMM configuration determination result 653 and CXL memory configuration information 651. The attribute management table controller 623 controls the attribute management table #1.

The SCP controller 624 issues a reboot instruction to the SCPFW 610. The reboot instruction is an instruction to restart the system S. Further, the SCP controller 624 receives, for example, a system reset request from the OS# or the like, and requests the SCPFW 610 to execute the system reset request.

Here, the CXL memory configuration information 651 will be described with reference to FIG. 8.

FIG. 8 is an explanatory diagram depicting a format example of CXL memory configuration information. In FIG. 8, the CXL memory configuration information 651 indicates a CXL memory number, a mounting flag, a valid flag, and a capacity (GB) for each CXL memory. The CXL memory number is an identifier for uniquely identifying the CXL memory. The mounting flag indicates whether the CXL memory is mounted in the PCIe Slot. Here, the mounting flag “1” indicates that the CXL memory is mounted. The mounting flag “0” indicates that the CXL memory is not mounted.

The valid flag indicates whether the mounted CXL memory is usable. Even when the CXL memory is mounted, the CXL memory may become unusable due to a failure or a configuration determination result of the system S. Here, the valid flag “1” indicates that the CXL memory is available. The valid flag “0” indicates that the CXL memory is unusable. The capacity (GB) indicates the capacity of the CXL memory.

As depicted in FIG. 6, the RMMFW 630 operates in the main memory (DIMMs #0 to #m) of the main system S1. The RMMFW 630 includes an attribute management table controller 631. The RMMFW 630 includes the attribute management table #2. The attribute management table #2 is attribute management information (for software control) for managing access attribute changes from software such as a hypervisor.

For example, when the access attribute is changed in units of pages from software, the RMMFW 630 updates the attribute management table #2 by the attribute management table controller 631 and updates the attribute management table #1 via the attribute management table controller 623 of the monitor FW 620. Thus, access attribute control by hardware is performed using the updated attribute management table #1.

The UEFIFW 640 operates in the main memory (DIMMs #0 to #m) of the main system S1. The UEFIFW 640 includes the configuration information reading unit 641, the CXL memory configuration detecting unit 642, the CXL memory configuration comparing/determining unit 643, the CXL memory configuration information change controller 644, and the monitor FW controller 645.

The configuration information reading unit 641 reads the DIMM/CXL memory configuration device tree 655 written by the monitor FW 620. The CXL memory configuration detecting unit 642 detects the configuration of the CXL memories #0 to #n coupled to the PCIe. The CXL memory configuration comparing and determining unit 643 compares and determines the old CXL memory configuration information and the new CXL memory configuration information.

The old CXL memory configuration information is CXL memory configuration information 651 included in the DIMM/CXL memory configuration device tree 655. The new CXL memory configuration information represents the configuration of the CXL memories #0 to #n detected by the CXL memory configuration detecting unit 642.

When the configurations of the CXL memories #0 to #n have changed, the CXL memory configuration information change controller 644 notifies the monitor FW 620 of the new CXL memory configuration information and requests the monitor FW 620 to rewrite the CXL memory configuration information (for example, the CXL memory configuration information 651) to the flash ROM 202.

The monitor FW controller 645 requests the monitor FW 620 to perform control. For example, when the configurations of the CXL memories #0 to #n have not changed, the monitor FW controller 645 sets a lock bit to the monitor FW 620 and starts the OS#.

Next, a procedure of a system startup process of the information processing device 100 according to the embodiment will be described with reference to FIGS. 9 to 11. Here, it is assumed that the configurations of the CXL memories #0 to #n have changed before the system S is started.

FIGS. 9, 10, and 11 are sequence diagrams depicting a procedure of the system startup process of the information processing device 100 according to the embodiment. In the sequence diagram depicted in FIG. 9, the information processing device 100 starts the system S (main system S1) by the SCPFW 610 (step S901).

Next, the information processing device 100 recognizes the configuration of the DIMMs #0 to #m by the SCPFW 610, compares the configuration with the mounting pattern allowed in the system S, and determines whether the DIMMs #0 to #m may be used for the system S (step S902). Then, the information processing device 100 causes the SCPFW 610 to store the DIMM configuration determination result 653 to the SRAM 203 of the main system S1 (step S903).

Next, the information processing device 100 reads the DIMM configuration determination result 653 from the SRAM 203 by the monitor FW 620 (step S904). Then, the information processing device 100 refers to the read DIMM configuration determination result 653 by the monitor FW 620 and thereby recognizes the configuration and total capacity of the DIMMs #0 to #m (step S905).

Specifically, for example, the information processing device 100 refers to the DIMM configuration determination result 653 by the monitor FW 620 and identifies the DIMMs in which both the mounting flag and the valid flag are set (1). Then, the information processing device 100 causes the monitor FW 620 to identify the sum of the capacities of the identified DIMMs as the total capacity of the DIMMs #0 to #m.

Next, the information processing device 100 reads the CXL memory configuration information 651 representing the configuration of the CXL memories #0 to #n recognized at the previous startup from the flash ROM 202 by the monitor FW 620 (step S906). Then, the information processing device 100 refers to the read CXL memory configuration information 651 by the monitor FW 620 and thereby recognizes the configuration and the total capacity of the CXL memories #0 to #n (step S907).

Specifically, for example, the information processing device 100 refers to the CXL memory configuration information 651 by the monitor FW 620 and thereby identifies the CXL memory in which both the mounting flag and the valid flag are set (1). Then, the information processing device 100 identifies the sum of the capacities of the identified CXL memories as the total capacity of the CXL memories #0 to #n by the monitor FW 620.

When the CXL memory configuration information is not stored in the flash ROM 202 at the initial startup of the system S or the like, the information processing device 100 may recognize the configuration and total capacity of the CXL memories #0 to #n as zero by the monitor FW 620.

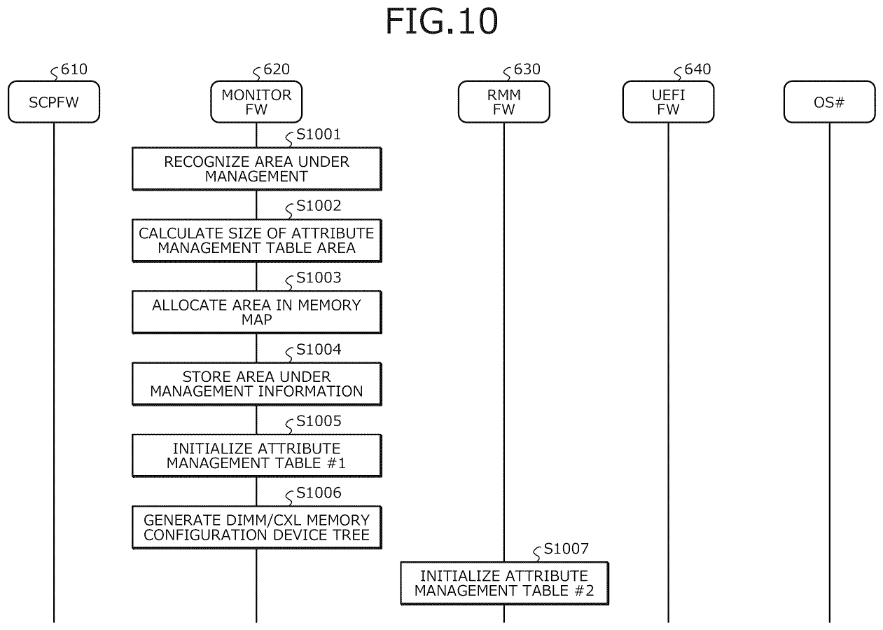

In the sequence diagram depicted in FIG. 10, the information processing device 100 recognizes the area under management from the total capacity of the identified DIMMs #0 to #m and CXL memories #0 to #n by the monitor FW 620 (step S1001). The area under management is a memory area for which access attributes are managed, in the overall physical address space of the system S.

Specifically, for example, the information processing device 100 recognizes, as the area under management, an area to which the total capacity of the total capacity of the DIMMs #0 to #m and the total capacity of the CXL memories #0 to #n is memory-mapped by the monitor FW 620.

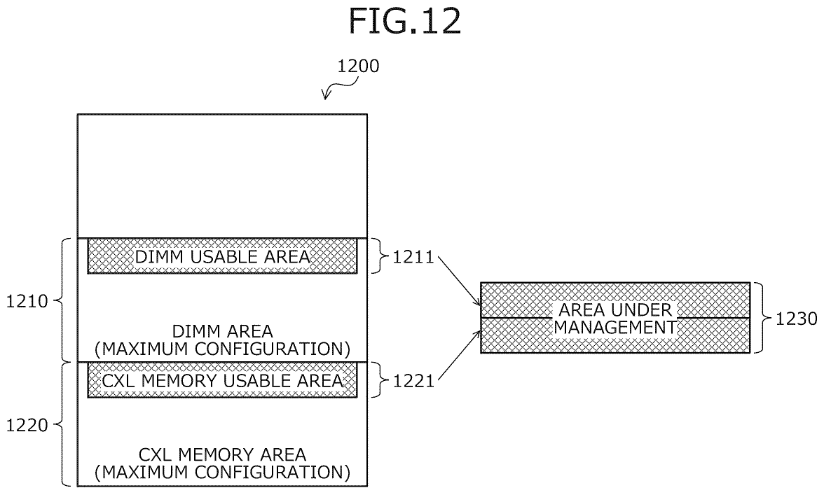

Here, the area under management will be described with reference to FIG. 12.

FIG. 12 is an explanatory diagram depicting an example of an area under management. In FIG. 12, a DIMM area 1210 and a CXL memory area 1220 of the entire physical address space 1200 of the system S are depicted. The DIMM area 1210 indicates an area of a maximum logical configuration (for example, all of the DIMMs #0 to #m are valid). The CXL memory area 1220 indicates an area having a maximum logical configuration (for example, all of the CXL memories #0 to #n are valid).

Here, in the DIMM area 1210, an area corresponding to the total capacity of the DIMMs #0 to #m identified from the DIMM configuration determination result 653 is recognized as a DIMM usable area 1211. In the CXL memory area 1220, an area corresponding to the total capacity of the CXL memories #0 to #n identified from the CXL memory configuration information 651 is recognized as a CXL memory usable area 1221.

The total of the DIMM usable area 1211 and the CXL memory usable area 1221 is recognized as an area under management 1230. The area under management 1230 has a smaller capacity than the maximum logical configuration (for example, the DIMM area 1210+the CXL memory area 1220).

As depicted in FIG. 10, the information processing device 100 calculates the size of the attribute management table area from the recognized area under management (for example, the area under management 1230 depicted in FIG. 12) by the monitor FW 620 (step S1002). The attribute management table area is an area for storing the attribute management tables #1 and #2. The area under management includes an attribute management table area.

Specifically, for example, the information processing device 100 may calculate the size of the attribute management table area using the following expression (1) by the monitor FW 620. The “area under management size” is the size of the area under management. The “page size” is a minimum unit for memory management. The “necessary size per page size” is a size of information (record) necessary for managing the access attribute of the area of the page size in each of the attribute management tables #1 and #2.

$$Area under management size / Page size * Necessary size per page size \qquad ( 1 )$$

For example, it is assumed that the area under management is the area under management 1230 depicted in FIG. 12. The area under management 1230 includes the DIMM usable area 1211 and the CXL memory usable area 1221. Further, it is assumed that the necessary size per page size is different between the attribute management tables #1 and #2. The necessary size per page size of the attribute management table #1 is referred to as “necessary size p1”, and the necessary size per page size of the attribute management table #2 is referred to as “necessary size p2”.

In this case, the information processing device 100 calculates the size of the attribute management table #1 by calculating “size of DIMM usable area 1211/page size*necessary size p1” by the monitor FW 620. In addition, the information processing device 100 calculates the size of the attribute management table #2 by calculating “the size of the CXL memory usable area 1221/the page size*necessary size p2” using the monitor FW 620. Then, the information processing device 100 causes the monitor FW 620 to calculate the size of the attribute management table area by adding the calculated size of the attribute management table #1 and the calculated size of the attribute management table #2.

Next, the information processing device 100 allocates an area (attribute management table area) corresponding to the calculated size, in the memory map by the monitor FW 620 (step S1003). Then, the information processing device 100 causes the monitor FW 620 to store the area under management information 654 indicating the area (attribute management table area) allocated in the memory map (step S1004). The area under management information 654 is, for example, information capable of identifying the recognized area under management, the area for storing the attribute management table #1, and the area for storing the attribute management table #2.

Next, the information processing device 100 refers to the area under management information 654 and initializes the attribute management table #1 by the monitor FW 620 (step S1005). Specifically, for example, the information processing device 100 recognizes the area under management by the monitor FW 620, generates the attribute management table #1 in the attribute management table area, and initializes the access attribute for each page size according to the access attribute (secure/non-secure) at the time of startup.

Then, the information processing device 100 causes the monitor FW 620 to generate the DIMM/CXL memory configuration device tree 655 from the DIMM configuration determination result 653 and the CXL memory configuration information 651 (step S1006). The DIMM/CXL memory configuration device tree 655 is for passing the configuration information of the DIMM and CXL memories recognized by the monitor FW 620 to the UEFIFW 640.

Next, the information processing device 100 refers to the area under management information 654 and initializes the attribute management table #2 by the RMMFW 630 (step S1007). Specifically, for example, the information processing device 100 recognizes the area under management by the RMMFW 630, generates the attribute management table #2 in the attribute management table area, and initializes the access attribute for each page size according to the access attribute (secure/non-secure) at the time of startup.

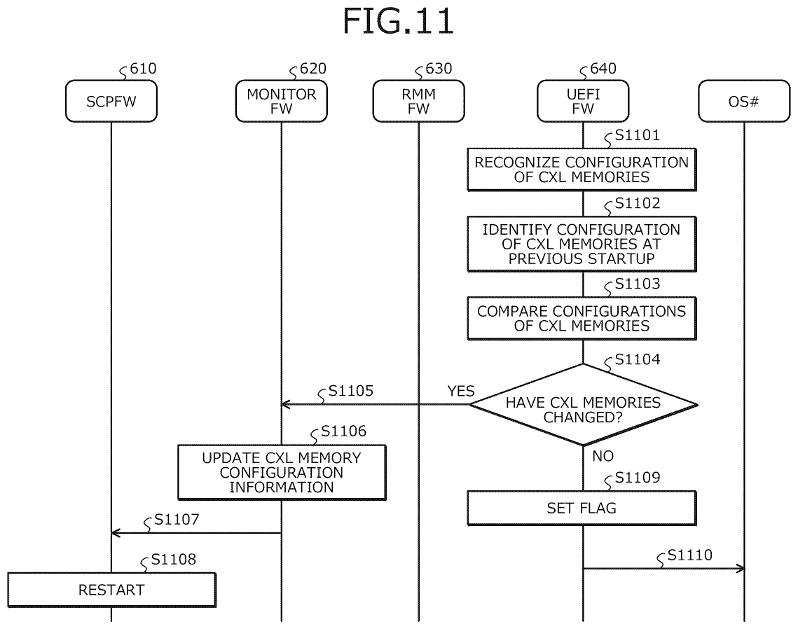

In the sequence diagram depicted in FIG. 11, the information processing device 100 recognizes the configuration of the CXL memories #0 to #n by detecting the CXL memories #0 to #n after the system startup by the UEFIFW 640 (step S1101). Further, the information processing device 100 refers to the DIMM/CXL memory configuration device tree 655 by the UEFIFW 640 and identifies the configuration of the CXL memories #0 to #n recognized at the previous startup (step S1102).

Next, the information processing device 100 compares the configuration of the CXL memories #0 to #n recognized at the time of the identified previous startup with the configuration of the CXL memories #0 to #n recognized at the time of the current startup at step S1101 by the UEFIFW 640 (step S1103). Then, the information processing device 100 determines whether the configurations of the CXL memories #0 to #n have changed, by the UEFIFW 640 (step S1104).

Here, the configurations of the CXL memories #0 to #n are changed before the system S is started. Therefore, at step S1104, it is determined that the configurations of the CXL memories #0 to #n have been changed.

Even when the configurations of the CXL memories #0 to #n are changed by the UEFIFW 640, the information processing device 100 may determine that the configurations of the CXL memories #0 to #n are not changed when the change does not affect the area under management. A change that does not affect the area under management is, for example, a change that does not increase or decrease the number of CXL memories but only changes the PCIe slot to which the CXL memories are coupled.

At step S1104, when the configurations of the CXL memories #0 to #n have changed (step S1104: YES), the information processing device 100 notifies the monitor FW 620 of CXL memory configuration information indicating the configurations of the CXL memories #0 to #n recognized at the current startup at step S1101 by the UEFIFW 640 (step S1105).

The information processing device 100 updates the CXL memory configuration information in the flash ROM 202 using the notified CXL memory configuration information by the monitor FW 620 (step S1106). In the monitor FW 620, the flash access controller 621 updates the notified CXL memory configuration information (new CXL memory configuration information) to flash only when the CXL memory configuration information lock flag 652 is not set (the lock bit is not set). The CXL memory configuration information in the ROM is overwritten.

Then, the information processing device 100 causes the monitor FW 620 to issue a reboot instruction to the SCPFW 610 (step S1107). The information processing device 100 causes the SCPFW 610 to restart the system S (main system S1) in response to the reboot instruction (step S1108).

When the system S (main system S1) is restarted, it is determined at step S1104 that the configurations of the CXL memories #0 to #n have not been changed.

At step S1104, when the configurations of the CXL memories #0 to #n are not changed (step S1104: NO), the information processing device 100 sets the CXL memory configuration information lock flag 652 by the UEFIFW 640 via the monitor FW 620 (step S1109).

By setting the CXL memory configuration information lock flag 652, it is possible to prevent the “CXL memory configuration information” from being rewritten by software having the same execution authority as the UEFIFW 640, such as a hypervisor. The CXL memory configuration information lock flag 652 is cleared when the system S is restarted.

Then, the information processing device 100 starts the OS# by the UEFIFW 640 (step S1110). As a result, the information processing device 100 may optimize the attribute management table area when the system S is started, and may increase the area usable by the OS# even in a configuration in which the number of DIMMs mounted on the system S is small.

As described above, according to the information processing device 100 of the embodiment, when the system S is started, the CXL memory configuration information indicating the configuration of the CXL memories #0 to #n (expansion memories) recognized when the system S started the previous time is read from the flash ROM 202, and the attribute management table area may be established in the DIMMs #0 to #m (main memories) based on the read CXL memory configuration information. The attribute management table area is an area for storing attribute management tables (attribute management tables #1 and #2) for managing access attributes of areas usable by the OS# in the entire physical address space of the system S. In addition, according to the information processing device 100, it is possible to recognize the configurations of the CXL memories #0 to #n in response to the detection of the CXL memories #0 to #n during the startup of the system S and to determine whether the configurations of the CXL memories #0 to #n have changed based on the result of comparing the configurations of the CXL memories #0 to #n represented by the read CXL memory configuration information with the recognized configurations of the CXL memories #0 to #n. Then, according to the information processing device 100, when the configuration of the CXL memories #0 to #n has changed, the CXL memory configuration information representing the recognized configuration of the CXL memories #0 to #n is written to the flash ROM 202, and the system S may be restarted. According to the information processing device 100, the OS# may be started when the configurations of the CXL memories #0 to #n have not changed.

As a result, the information processing device 100 may increase the memory area usable by the OS# by optimizing the attribute management table area when the system S is started. For example, the information processing device 100 may increase the memory area usable by the OS# by suppressing the size of the attribute management table area in the DIMMs #0 to #m as compared with the case where the area corresponding to the maximum logical configuration capacity is established for the configuration-changeable CXL memories #0 to #n.

Further, according to the information processing device 100, when the system S is started, the configuration of the DIMMs #0 to #m may be recognized, and the attribute management table area may be established in the DIMMs #0 to #m based on the recognized configuration of the DIMMs #0 to #m and the read CXL memory configuration information.

Accordingly, the information processing device 100 may optimize the attribute management table area with consideration of the configurations of the DIMMs #0 to #m whose configurations may be changed, and may increase the memory area usable by the OS#.

Further, according to the information processing device 100, when the system S including the main system S1 and the subsystem S2 is started, the configuration of the DIMMs #0 to #m may be recognized by referring to the DIMM configuration information (for example, the DIMM configuration determination result 653) representing the configuration of the DIMMs #0 to #m recognized by the subsystem S2.

Accordingly, the information processing device 100 may recognize the configuration of the DIMMs #0 to #m of the main system S1 by using the subsystem S2 that operates independently of the main system S1.

As described above, according to the system startup program, the system startup method, and the information processing device 100 of the embodiment, it is possible to increase the memory area usable by the OS# by optimizing the attribute management table area even in a configuration in which the number of DIMMs mounted in the system S is small. For example, by applying the system startup method to a server system that performs AI training or inference, a sufficient memory area may be allocated from the OS# to software that performs learning or inference, and processing performance may be improved.

Here, an example of reducing the size of the attribute management table area will be described.

Here, it is assumed that the total of the DIMM area and the CXL memory area of the maximum logical configuration of the system S is “100 [TB]”, the page size is “4 [KB]”, and the size necessary for management per page size is “4.5 [Bytes]”. Further, it is assumed that the total of the DIMM capacity and the CXL memory capacity actually mounted in the system S is “256 [GB]”.

In this case, in the conventional method, the size of the attribute management table area (for example, the area for storing the attribute management table #1) is “100 [TB]/4 [KB]*4.5 [Bytes]≈113 [GB]”. The OS usable area is “256 [GB]−113 [GB]≈143 [GB]”.

On the other hand, in the present system startup method, the size of the attribute management table area is “256 [GB]/4 [KB]*4.5 [Bytes]≈228 [MB]”. The OS-usable area is “256 [GB]−228 [MB]≈255 [GB]”. As described above, according to the present system starting method, the memory area usable by the OS# may be significantly increased as compared with the conventional method.

The system starting method described in the present embodiment may be implemented by executing a prepared program on a computer such as a personal computer and a workstation. The system starting program is stored on a non-transitory, computer-readable recording medium such as a hard disk, a flexible disk, a compact disc read-only memory (CD-ROM), a digital versatile disc (DVD), or a universal serial bus (USB) memory, read out from the computer-readable medium, and executed by the computer. The program may be distributed through a network such as the Internet.

According to one aspect, the present disclosure achieves an effect in that memory areas available for use by the OS may be increased.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing therein a program for causing a computer to execute a process, the process comprising:
reading memory configuration information from a nonvolatile memory, when a system including a main memory, an expansion memory, and the nonvolatile memory is started, the memory configuration information representing a configuration of the expansion memory recognized at a last startup of the system;
establishing in the main memory and based on the read memory configuration information, an area for storing attribute management information for managing an access attribute of an area usable by an OS in an entire physical address space of the system;
recognizing the configuration of the expansion memory in response to detection of the expansion memory during startup of the system;
determining whether the configuration of the expansion memory has changed based on a result of comparison of the configuration of the expansion memory represented by the memory configuration information and the recognized configuration of the expansion memory;
writing updated memory configuration information and restarting the system, the updated memory configuration information representing the recognized configuration of the expansion memory and being written to the nonvolatile memory when the configuration of the expansion memory has changed; and
starting the OS when the configuration of the extension memory has not changed.

2. The computer-readable recording medium according to claim 1, the process further comprising:
recognizing a configuration of the main memory at startup of the system; and
establishing an area for storing the attribute management information in the main memory based on the recognized configuration of the main memory and the read memory configuration information.

3. The computer-readable recording medium according to claim 2, wherein
the main memory is a DIMM, and
the extension memory is a CXL memory coupled to a PCIe.

4. The computer-readable recording medium according to claim 2, wherein
the system includes a main system in which the OS operates and a subsystem for controlling startup of the main system, and
the recognizing the configuration of the main memory includes recognizing the configuration of the main memory by referring to configuration information representing the configuration of the main memory recognized by the subsystem at the startup of the system.

5. The computer-readable recording medium according to claim 4, wherein
the main system includes a boot loader firmware that operates first when the main system is started and performs basic initialization, and a UEFI firmware that performs initialization of a PCIe not performed in the basic initialization,
the reading the memory configuration information from the nonvolatile memory and the establishing the area for storing the attribute management information in the main memory are performed by the boot loader firmware,
the recognizing the configuration of the expansion memory and the determining whether the configuration of the expansion memory has changed based on the result of the comparison of the configuration of the expansion memory represented by the read memory configuration information and the recognized configuration of the expansion memory are performed by the UEFI firmware,
the process further comprises:
notifying the boot loader firmware of the updated memory configuration information representing the recognized configuration of the expansion memory, the UEFI firmware performing the notifying when the configuration of the expansion memory has changed; and
storing the notified updated memory configuration information to the nonvolatile memory and instructing the subsystem to restart the system, the boot loader firmware performing the storing and the instructing.

6. The computer-readable recording medium according to claim 5, wherein the starting the OS when the configuration of the expansion memory has not changed is performed by the UEFI firmware.

7. A system starting method executed by a computer, the system starting method comprising:
reading memory configuration information from a nonvolatile memory, when a system including a main memory, an expansion memory, and the nonvolatile memory is started, the memory configuration information representing a configuration of the expansion memory recognized at a last startup of the system;
establishing in the main memory and based on the read memory configuration information, an area for storing attribute management information for managing an access attribute of an area usable by an OS in an entire physical address space of the system;
recognizing the configuration of the expansion memory in response to detection of the expansion memory during startup of the system;
determining whether the configuration of the expansion memory has changed based on a result of comparison of the configuration of the expansion memory represented by the memory configuration information and the recognized configuration of the expansion memory;
writing updated memory configuration information and restarting the system, the updated memory configuration information representing the recognized configuration of the expansion memory and being written to the nonvolatile memory when the configuration of the expansion memory has changed; and
starting the OS when the configuration of the extension memory has not changed.

8. An information processing device comprising:
a memory; and
a processor coupled to the memory, the processor configured to:
read memory configuration information from a nonvolatile memory, when a system including a main memory, an expansion memory, and the nonvolatile memory is started, the memory configuration information representing a configuration of the expansion memory recognized at a last startup of the system;
establish in the main memory and based on the read memory configuration information, an area for storing attribute management information for managing an access attribute of an area usable by an OS in an entire physical address space of the system;
recognize the configuration of the expansion memory in response to detection of the expansion memory during startup of the system;
determine whether the configuration of the expansion memory has changed based on a result of comparison of the configuration of the expansion memory represented by the memory configuration information and the recognized configuration of the expansion memory;
write updated memory configuration information and restarting the system, the updated memory configuration information representing the recognized configuration of the expansion memory and being written to the nonvolatile memory when the configuration of the expansion memory has changed; and
start the OS when the configuration of the extension memory has not changed.
